(19) United States
(12) Patent Application Publication
(10) Pub. No.: US 2026/0046835 A1
(43) Pub. Date: Feb. 12, 2026

(54) THREE DIMENSIONAL SEARCH AND POSITIONING IN WIRELESS COMMUNICATIONS SYSTEMS

(71) Applicant: QUALCOMM INCORPORATED, San Diego, CA (US)

(72) Inventors: Danlu Zhang, San Diego, CA (US); Yu Zhang, San Diego, CA (US); Tingfang Ji, San Diego, CA (US)

(21) Appl. No.: 19/100,477

(22) PCT Filed: Sep. 20, 2022
(86) PCT No.: PCT/CN2022/119788

§ 371 Date: Jan. 31, 2025

(51) Int. Cl. H04W 64/00; H04B 7/06; H04L 5/00

(52) U.S. Cl. CPC H04W 64/006; H04B 7/0617; H04L 5/0051

(57) ABSTRACT

Methods, systems, and devices for wireless communications are described. A first wireless device (e.g., a user equipment (UE) or a network entity) may identify a set of estimates of distance for a plurality of devices in a first direction between the first wireless device and a second wireless device. The first wireless device may identify a possible location using a pair of coordinate values for a second direction and a third direction, where the possible location is for the second wireless device in relation to the first wireless device. Based on the set of estimates of distance and the possible location of the second wireless device, the first wireless device may determine a set of parameters for a three-dimensional beamforming procedure, the set of parameters including inputs to the three-dimensional beamforming procedure. The first wireless device may communicate with the second wireless device in accordance with the three-dimensional beamforming procedure.

### CROSS REFERENCE

This application is a 371 National Stage of PCT Application No. PCT/CN2022/119788, filed on Sep. 20, 2022, entitled “THREE DIMENSIONAL SEARCH AND POSITIONING IN WIRELESS COMMUNICATIONS SYSTEMS”, and assigned to the assignee hereof. The disclosure of the prior application is considered part of and is incorporated by reference into this patent application.

### FIELD OF TECHNOLOGY

The following relates to wireless communications, including three dimensional search and positioning in wireless communications systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A transmitting device (e.g., a UE or network entity) may perform beamforming with a receiving device. Performing three-dimensional beamforming may include using a depth parameter to focus a beam in the near field. In some cases, the receiving wireless device may be near other wireless devices and reflectors, and the transmitting wireless device may be unable to distinguish the single receiving wireless device from the multitude of other wireless devices or reflections unless the receiving wireless device is within a line-of-sight. As such, some wireless communication systems may not provide for a wireless device to perform three dimensional beamforming when a receiving wireless device is not within line-of-sight of the transmitting device.

### SUMMARY

The described techniques relate to improved methods, systems, devices, and apparatuses that support three dimensional search and positioning in wireless communications systems. For example, the described techniques provide for a transmitting device may to perform three-dimensional beamforming with a receiving device that may be within a line-of-sight or out of a line-of-sight. The transmitting device (e.g., a network entity or base station) may identify a focus depth and then run a focus Fourier Transform, which is a modified Fourier Transform with depth compensation, to accurately estimate the location and distance of a receiving device (e.g., a user equipment (UE)) for performing three-dimensional beamforming. In some cases, for example in a downlink centric approach, the network entity may scan multiple distances and locations by transmitting multiple three dimensional beamformed reference signals (each to a different distance or location). When a UE receives one of the transmitted reference signals, the UE may measure the beam reception quality and report feedback measurements to the network entity.

Alternatively, in an uplink centric approach, the UE may transmit a reference signal to the network entity and the network entity may estimate the location of the UE using a focus Fourier transform from the received reference signal. In either option, the network entity may then use the determined distance and location information to generate a three-dimensional beamform. In both the downlink centric approach and uplink centric approach, the transmitting device may use various methods for estimating the distance. For example, in a search-based method the transmitting device may find a peak energy by running cross correlations at different times. In another example, the transmitting device may perform a phase-based method which measures the relative phase between segments of the received waveform. In another example, the receiving device may perform a scan and feedback method by providing feedback to the transmitting device on how strong the received signals are. After the distance has been determined, the transmitting device may perform a focus Fourier transform on the distance to identify the intended object from a set of objects and then perform three-dimensional beamforming.

A method for wireless communication at a first wireless device is described. The method may include identifying a set of multiple estimates of distance for a plurality of devices in a first direction between the first wireless device and a second wireless device, identifying a possible location using a pair of coordinate values for a second direction and a third direction, where the possible location is for the second wireless device in relation to the first wireless device, determining, based on the set of multiple estimates of distance and the possible location of the second wireless device, a set of multiple parameters for a three-dimensional beamforming procedure, the set of multiple parameters including inputs to the three-dimensional beamforming procedure, and communicating with the second wireless device in accordance with the three-dimensional beamforming procedure.

An apparatus for wireless communication at a first wireless device is described. The apparatus may include a processor, memory coupled with the processor, and instructions stored in the memory. The instructions may be executable by the processor to cause the apparatus to identify a set of multiple estimates of distance for a plurality of devices in a first direction between the first wireless device and a second wireless device, identify a possible location using a pair of coordinate values for a second direction and a third direction, where the possible location is for the second wireless device in relation to the first wireless device, determine, based on the set of multiple estimates of distance and the possible location of the second wireless device, a set of multiple parameters for a three-dimensional beamforming procedure, the set of multiple parameters including inputs to the three-dimensional beamforming procedure, and communicate with the second wireless device in accordance with the three-dimensional beamforming procedure.

Another apparatus for wireless communication at a first wireless device is described. The apparatus may include means for identifying a set of multiple estimates of distance for a plurality of devices in a first direction between the first wireless device and a second wireless device, means for identifying a possible location using a pair of coordinate values for a second direction and a third direction, where the possible location is for the second wireless device in relation to the first wireless device, means for determining, based on the set of multiple estimates of distance and the possible location of the second wireless device, a set of multiple parameters for a three-dimensional beamforming procedure, the set of multiple parameters including inputs to the three-dimensional beamforming procedure, and means for communicating with the second wireless device in accordance with the three-dimensional beamforming procedure.

A non-transitory computer-readable medium storing code for wireless communication at a first wireless device is described. The code may include instructions executable by a processor to identify a set of multiple estimates of distance for a plurality of devices in a first direction between the first wireless device and a second wireless device, identify a possible location using a pair of coordinate values for a second direction and a third direction, where the possible location is for the second wireless device in relation to the first wireless device, determine, based on the set of multiple estimates of distance and the possible location of the second wireless device, a set of multiple parameters for a three-dimensional beamforming procedure, the set of multiple parameters including inputs to the three-dimensional beamforming procedure, and communicate with the second wireless device in accordance with the three-dimensional beamforming procedure.

Some examples of the method, apparatuses, and non-transitory computer-readable medium described herein may further include operations, features, means, or instructions for performing the three-dimensional beamforming procedure during wireless communication between the first wireless device and the second wireless device using at least one of the determined set of multiple parameters.

In some examples of the method, apparatuses, and non-transitory computer-readable medium described herein, performing the three-dimensional beamforming procedure may include operations, features, means, or instructions for using an estimated channel response for determining the set of multiple parameters for transmitting a three-dimensional beam.

Some examples of the method, apparatuses, and non-transitory computer-readable medium described herein may further include operations, features, means, or instructions for performing the three-dimensional beamforming procedure may be associated with a channel estimation signal-to-noise-ratio satisfying a threshold.

Some examples of the method, apparatuses, and non-transitory computer-readable medium described herein may further include operations, features, means, or instructions for identifying the possible location of the second wireless device includes performing a Fourier transform using a coordinate value for the first direction as an input.

In some examples of the method, apparatuses, and non-transitory computer-readable medium described herein, the focus Fourier transform may be performed using a simplification that increases an angular resolution.

In some examples of the method, apparatuses, and non-transitory computer-readable medium described herein, at least one of the set of multiple estimates of distance corresponds to a reflection of the second wireless device.

In some examples of the method, apparatuses, and non-transitory computer-readable medium described herein, the set of multiple parameters include one or more of a set of multiple antenna phases for a corresponding one or more of a set of multiple antenna elements at the first wireless device.

In some examples of the method, apparatuses, and non-transitory computer-readable medium described herein, identifying the possible location of the second wireless device may include operations, features, means, or instructions for transmitting a set of multiple three-dimensional beamformed reference signals at a set of multiple locations and at a set of multiple distances based on the set of multiple estimates of distance and receiving, from a set of multiple signal sources including the second wireless device, respective indications of corresponding ones of the set of multiple three-dimensional beamformed reference signals, the corresponding ones of the set of multiple three-dimensional beamformed reference signals being associated with peak received energy at each of the set of multiple signal sources, where the respective locations of the set of multiple signal sources may be identified based on the respective indications.

In some examples of the method, apparatuses, and non-transitory computer-readable medium described herein, identifying the possible location of the second wireless device may include operations, features, means, or instructions for receiving, from a set of multiple signal sources including the second wireless device, one or more reference signals and estimating respective locations of the set of multiple signal sources based on differences in relative phase of the one or more reference signals, as received at different antenna elements of the first wireless device.

In some examples of the method, apparatuses, and non-transitory computer-readable medium described herein, estimating respective locations of the set of multiple signal sources may include operations, features, means, or instructions for performing a Fourier transform based on the one or more reference signals and the identified estimates of distance in order to identify the differences in relative phase of the one or more reference signals.

In some examples of the method, apparatuses, and non-transitory computer-readable medium described herein, determining the set of multiple parameters may include operations, features, means, or instructions for isolating one or more phase terms from the Fourier transform, where the one or more phase terms may be included in the set of multiple parameters.

Some examples of the method, apparatuses, and non-transitory computer-readable medium described herein may further include operations, features, means, or instructions for identifying a set of multiple signal sources including the second wireless device based on identifying the respective locations of the set of multiple signal sources, where the set of multiple signal sources includes one or a set of multiple physical objects and one or a set of multiple reflections of the set of multiple physical objects.

In some examples of the method, apparatuses, and non-transitory computer-readable medium described herein, identifying the possible location of the second wireless device may include operations, features, means, or instructions for identifying respective locations of a set of multiple signal sources including the second wireless device based on an output from a neural network.

In some examples of the method, apparatuses, and non-transitory computer-readable medium described herein, the first wireless device and the second wireless device may be not within line of sight of each other.

In some examples of the method, apparatuses, and non-transitory computer-readable medium described herein, the set of multiple estimates of distance may be used to characterize reflectors.

### BRIEF DESCRIPTION OF THE DRAWINGS

FIG. 1 illustrates an example of a wireless communications system that supports three dimensional search and positioning in wireless communications systems in accordance with one or more aspects of the present disclosure.

FIG. 2 illustrates an example of a wireless communication system that supports three dimensional search and positioning in wireless communications systems in accordance with one or more aspects of the present disclosure.

FIG. 3 illustrates an example of a process flow that supports three dimensional search and positioning in wireless communications systems in accordance with one or more aspects of the present disclosure.

FIGS. 4 and 5 show block diagrams of devices that support three dimensional search and positioning in wireless communications systems in accordance with one or more aspects of the present disclosure.

FIG. 6 shows a block diagram of a communications manager that supports three dimensional search and positioning in wireless communications systems in accordance with one or more aspects of the present disclosure.

FIG. 7 shows a diagram of a system including a UE that supports three dimensional search and positioning in wireless communications systems in accordance with one or more aspects of the present disclosure.

FIG. 8 shows a diagram of a system including a network entity that supports three dimensional search and positioning in wireless communications systems in accordance with one or more aspects of the present disclosure.

FIGS. 9 and 10 show flowcharts illustrating methods that support three dimensional search and positioning in wireless communications systems in accordance with one or more aspects of the present disclosure.

### DETAILED DESCRIPTION

In some wireless communication systems, wireless devices may perform three dimensional beamforming. A wireless device (e.g., network entity or user equipment (UE)) may utilize a holographic multiple input multiple output (MIMO) system to transmit one or more beams with three dimensional beamforming. In three dimensional beamforming, a wireless device may use a depth parameter in addition to two dimensional beamforming parameters to focus a beam towards a receiving wireless device (e.g., network entity or UE) at a specific location in the near field. In some cases, the receiving wireless device may be near other wireless devices, and the transmitting wireless device may be unable to distinguish the single receiving wireless device from the multitude of other wireless devices unless the receiving wireless device is within a line-of-sight. As such, some wireless communication systems may not provide for a wireless device to perform three dimensional beamforming when a receiving wireless device is not within line-of-sight of the transmitting device.

The techniques, apparatuses, and methods described herein provide for a transmitting device to target a receiving device from a multitude of other signal sources (e.g., wireless devices or reflectors) for three dimensional beamforming. Specifically, the transmitting device may identify a focus depth and may determine a location of one or more wireless devices using the focus depth. The focus depth may refer to a measure of placement of a plane of the receiving device in relation to the multitude of other signal sources. For instance, when estimating a location of a particular receiving wireless device, the transmitting wireless device may identify a set of estimates of distance along a coordinate value for a first direction of a distance between the transmitting device and the receiving device. The transmitting device may identify a possible location for the receiving device and may determine parameters for a three-dimensional beamforming procedure to the receiving device using the set of estimates of distance and the possible location. The transmitting device may then perform a three-dimensional beamforming procedure during wireless communication with the receiving device using at least one of determined parameters. In one aspect, the transmitting device may rely on uplink reference signals from the receiving device to estimate the location of the receiving device. In another aspect, the transmitting device may rely on downlink reference signals to estimate the location of the receiving device. The transmitting device may perform a focus Fourier Transform using the reference signals and focus depth to accurately estimate the location and distance of the receiving device for performing three-dimensional beamforming. From this calculation, the transmitting device may determine three dimensional beamforming parameters for communicating with the receiving device.

Aspects of the disclosure are initially described in the context of wireless communications systems. Aspects of the disclosure are further illustrated by and described with reference to an additional wireless communications system, process flow, apparatus diagrams, system diagrams, and flowcharts that relate to three dimensional search and positioning in wireless communications systems.

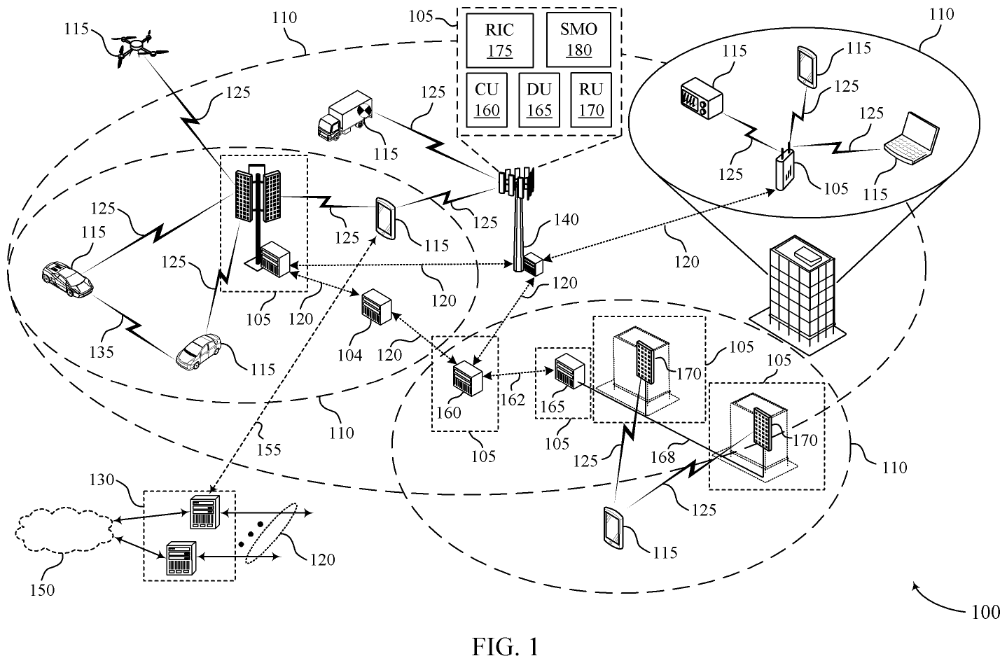

FIG. 1 illustrates an example of a wireless communications system 100 that supports three dimensional search and positioning in wireless communications systems in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support three dimensional search and positioning in wireless communications systems as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

Some wireless communication systems may be configured to use beamforming techniques which may support both direction and distance discrimination. For example, a transmitting device (e.g., network entity or UE) may be configured to perform three dimensional beamforming techniques, where the transmitting device may form three dimensional transmission beams using different antenna panels to a receiving device that may distinguish both direction and distance between the receiving device and the transmitting device. As such, the transmitting device may focus the transmission beam toward a point to a user in the diffractive near-field, instead of sending a signal in a general direction as may be done in two dimensional beamforming. In particular, a three dimensional beam may differ from a two dimensional beam in that it may include a depth parameter. Specifically, the transmitting device may use distance and target location as parameters for the three dimensional beamforming. However, a three-dimensional beam may be less efficient if the depth parameter is not accurately determined. In some cases, a transmitting device may be able to perform three dimensional beamforming within a line-of-sight of the receiving device.

In optics, a reflection by a mirror-like surface may create a virtual image. In some cases, multiple reflections may be present, creating multiple virtual images. As such, a virtual image may be perceived as the real object or source. Therefore, identifying multiple reflections may not lead to accurately locating the real source, because two reflections may be mistakenly identified as a source-image pair. Similarly, in wireless communications, a wireless transmitter (e.g., transmitting device) may perceive multiple objects as potential receivers (e.g., receiving devices) and may distinguish between the multiple objects to identify a target receiver. According to the present disclosure, the transmitting device may identify multiple distance estimates along a first direction (e.g., z-direction) of a distance between the transmitting device and the receiving device. In some cases, the transmitting device may determine the location of the receiving device by computing a Fourier transform of a received waveform. The received waveform may be based on a reference signal transmitted to the receiving device. For example, the transmitting device may transmit multiple three-dimensional beamformed reference signals to multiple locations and distances based on multiple distance estimates.

The receiving device may receive one or more of the reference signals, measure the beam reception quality, and transmit an indication corresponding to the reference signals associated with a peak received energy. The transmitting device may use the received indication for distance estimate to identify a possible location of the receiving device. Additionally, or alternatively, one or more receiving devices may transmit one or more reference signals that are received by the transmitting device. The transmitting device may perform a Fourier transform based on the received one or more reference signals and may use the identified distances in order to identify the differences in relative phase of the one or more reference signals.

Accordingly, the transmitting device may estimate the locations of the one or more receiving devices based on the differences in relative phase between the received reference signals. Use of the relative phase may provide the benefit of avoiding degradation of the signal from phase noise. However, in some cases, the result of a Fourier transform calculation may not be useful (e.g., because the transmitting device may be unable to estimate the location of a source or object using the energy of the Fourier transform) unless distance is compensated for. Distance compensation may be computed based on the assumption that the receiver antenna has a finite size of radius R such that computing the Fourier transform using the phase of the antenna may result in a finite energy value. As such, a focus Fourier transform that utilizes distance compensation may provide enhance the accuracy of a method for estimating the location and distance of multiple objects. Although the transmitting device may accurately identify multiple objects and estimate locations using a Fourier transform, the transmitting device may experience errors in pairing each identified object with its corresponding estimated location. To mitigate such errors in the pairing between estimated locations and identified objects, the transmitting device may pair a strongest point (e.g., point corresponding to a strongest received energy) or a point with a minimum distance with each identified object. For example, the transmitting device may identify, along one direction, multiple estimates of distance between the transmitting device and a possible receiving device. The transmitting device may also identify a possible location (e.g., coordinate pair for a second and third direction) for the receiving device and determine based on the distance estimates and the possible location for the receiving device a set of parameters for three-dimensional beamforming. The transmitting device may perform a three-dimensional beamforming procedure with the receiving device using the set of parameters.

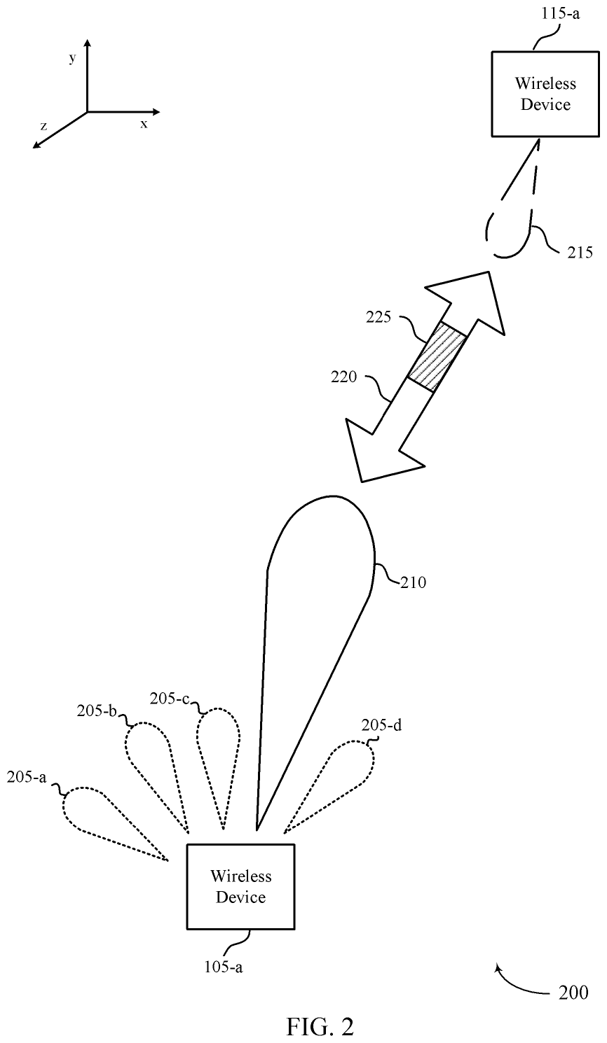

FIG. 2 illustrates an example of a wireless communication system 200 that supports three dimensional search and positioning in wireless communications systems in accordance with one or more aspects of the present disclosure. In some examples, wireless communications system 200 may be implemented by one or more aspects of wireless communications system 100. For instance, wireless device 105-a and wireless device 115-a may each be an example of either a UE 115 or network entity 105 as described with reference to FIG. 1, and either device may be a transmitting device or a receiving device. For purposes of illustration, the wireless communications system 200 may assume that wireless device 105-a is an example of a network entity 105 and wireless device 115-a is an example of UE 115. Wireless device 105-a and wireless device 115-a may communicate over a communication link 220. Wireless device 105-a and wireless device 115-a may be out of line-of-sight of each other and communicate using three-dimensional beamforming.

In some cases, wireless device 115-a may be one of a multitude of objects M within receiving distance of wireless device 105-a. Wireless device 115-a may be located at coordinates (xₘ, vₘ, zₘ). In the two dimensional x-z plane, each object may have coordinates (xₘ, zₘ) where m=0, 1, . . . (M−1). Although the equations described herein may be defined in two dimensions, it may be assumed that the y-component can be treated in the same way as the x-component and therefore the equations described herein may be extended to the third dimension in a similar manner. As illustrated in FIG. 2., wireless device 115-a, may be located at (x, 0). Wireless device 105-a may receive a waveform from multiple objects or M sources, which waveform may be approximated par-axially (e.g., in the far field) as:

$${\sum }_{m = 0}^{M - 1} {a}_{m} exp ( jk \sqrt{{( x - {x}_{m} )}^{2} + {z}_{m}^{2}} ) \qquad ( 1 )$$

$$\approx {\sum }_{m = 0}^{M - 1} {a}_{m} exp ( {jkz}_{m} ) exp \frac{{jk ( x - {x}_{m} )}^{2}}{2 {z}_{m}} \qquad ( 2 )$$

$$= {\sum }_{m = 0}^{M - 1} {a}_{m} exp ( {jkz}_{m} ) exp \frac{{jkx}_{m}^{2}}{2 {z}_{m}} exp \frac{- {jkx}_{m} x}{{z}_{m}} exp \frac{{jkx}^{2}}{2 {z}_{m}} \qquad ( 3 )$$

The received signal amplitude, A(x), from the M-th source may further be defined in equation (4).

$${A}_{m} ( x ) ∝ \{ \begin{matrix}exp \frac{- {jkx}_{m} x}{{z}_{m}} exp \frac{{jkx}^{2}}{2 {z}_{m}} & \vert x \vert \leq R \\ 0 & \vert x \vert > R\end{matrix} \qquad ( 4 )$$

Wireless device 105-a may process the received signal A(x) by performing a Fourier transform using the coordinate value for the first direction (e.g., z coordinate) as input as shown in equation (5).

$$ℱ [ {A}_{m} ( x ) ] ∝ ℱ [ exp \frac{- {jkx}_{m} x}{{z}_{m}} exp \frac{{jkx}^{2}}{2 {z}_{m}} ] = ℱ [ exp \frac{- {jkx}_{m} x}{{z}_{m}} ] ⊗ ℱ [ exp \frac{{jkx}^{2}}{2 {z}_{m}} ] \qquad ( 5 )$$

However, without compensating for distance, equation (5) may produce a suboptimal result. In some cases, a Fourier transform of the received signal phase determined in this manner may result in an infinite frequency. Additionally, or alternatively, depth and frequency (e.g., angle) resolutions may be suboptimal because xₘ<R. To overcome such limitations, wireless device 105-a may utilize a distance estimate in order to focus and achieve a finer resolution of the perpendicular plane at the distance. Such resolution may be achieved by incorporating a phase term exp

$$( - \frac{{jkx}^{2}}{2 {\hat{z}}_{m}} )$$

to the received waveform Aₘ(x) shown in equation (4). This may be seen as a spherical wave converging, or being focused onto a distance \hat{z}ₘ. In some cases, wireless device 105-a may estimate or compensate for zₘ if the term is unknown. For example, the wireless device 105-a may use a predefined value for zₘ in the in equation (4), if the term zₘ is unknown. In some cases, the phase term may be referred to as the distance focus term. The distance focus term may apply to each of the source and the multiple objects in the received waveform. As such, equation (5) may be modified to equation (6), which includes the phase term. This method of Fourier transform with depth compensation (such as compensation for the term zₘ) or distance focus term can be called “focus Fourier transform.”

$$ℱ [ {A}_{m} ( x ) exp ( - \frac{{jkx}^{2}}{2 {\hat{z}}_{m}} ) ] ∝ ℱ [ exp \frac{- {jkx}_{m} x}{{z}_{m}} exp \frac{{jkx}^{2}}{2 {z}_{m}} exp ( - \frac{{jkx}^{2}}{2 {\hat{z}}_{m}} ) ] = ℱ [ exp \frac{- {jkx}_{m} x}{{z}_{m}} ] ⊗ ℱ [ exp \frac{{jkx}^{2}}{2} ( \frac{1}{{z}_{m}} - \frac{1}{{\hat{z}}_{m}} ) ] \qquad ( 6 )$$

The result of equation (6) may be an energy level approximated as

$$\frac{R}{λ} ( \frac{1}{{z}_{m}} - \frac{1}{{\hat{z}}_{m}} )$$

at a frequency

$$\frac{{x}_{m}}{λ {z}_{m}} .$$

Additionally, the frequency (e.g., angle) resolution may be further improved if \hat{z}ₘ≈zₘ. That is, with a good estimate of distance zₘ and a term for depth compensation, the angular resolution of the equation (6) may be significantly enhanced. For estimate of distance zₘ, wireless device 105-a may use multiple hypotheses of zₘ in order to find a good distance (e.g., an accurate distance).). Note that the above example is an example using paraxial approximation as an example to illustrate how a depth compensation can be made. One can readily appreciate that the methodology applied in the example also applies to other uses cases, i.e., additionally introducing depth compensation to enhance depth and/or angular resolution of beamforming.

For distance estimation of zₘ, in one implementation, wireless device 105-a may estimate the distance zₘ of wireless device 115-a using searcher or cross-correlation based timing estimations. Wireless device 105-a may estimate distances using a total delay, which may be proportional to \sqrt{(x−xₘ)²+(y−yₘ)²+zₘ}. Wireless device 105-a may calculate peak energies associated with each estimated distance and select the distance associated with a highest peak energy. For example, wireless device 105-a may run cross-correlations at different time periods to find different peak energies and may determine a highest peak energy from the multiple peak energies. The resolution of the search may be a fraction of a chip duration, which may be defined as 1/bandwidth, where bandwidth may be of the reference signal. Such resolution may be adequate for determining an initial estimate of zₘ. In some cases, wireless device 105-a and wireless device 115-a may not be synchronized in which case a round trip time (RTT) estimation may be used to estimate a one-way propagation delay. As such, wireless device 115-a and wireless device 105-a may perform signaling to switch the transmitter and receiver roles such that wireless device 115-a may measure a one-way delay from a signal received from wireless device 105-a.

In another implementation, wireless device 105-a may estimate the distance zₘ of wireless device 115-a using the phase of the received waveform. Specifically, wireless device 105-a may measure segments in the waveform received from multiple objects. For example, wireless device 105-a may identify a segment in the received waveform and measure the relative phase exp

$$\frac{{jk ( x - {x}_{m} )}^{2}}{2 {z}_{m}} exp \frac{{jk ( y - {y}_{m} )}^{2}}{2 {z}_{m}}$$

of the received waveform. In some cases, the relative phase may be more stable than the absolute phase of the waveform. Wireless device 105-a may repeat measurement of the relative phase for multiple received waveforms at different locations. In some cases, wireless device 105-a may attempt to measure multiple segments within the received waveform because the quantity of sources or the locations of the sources may be unknown. Wireless device 105-a may use a relative phase to avoid degradation from phase noise.

In another implementation, wireless device 105-a may estimate the distance zₘ of wireless device 115-a by scanning and receiving feedback. Both the transmitting device (e.g., wireless device 105-a) and the receiving device (e.g., wireless device 115-a) may perform the scanning. For example, in a downlink centric procedure, wireless device 105-a may scan across multiple distances and locations using beams 205. Wireless device 105-a may identify a possible location using a pair of coordinate values for a second direction and a third direction by transmitting multiple three-dimensional beamformed reference signals using beam 205 at multiple locations and at multiple distances based on the distance estimate. A receiving device (e.g., wireless device 115-a), may receive one or more of the beams 205 and perform measurements on the beams 205, such as beam reception quality. Wireless device 115-a may transmit a corresponding feedback message 225 to wireless device 105-a that includes an indication of the beam measurements. Wireless device 105-a may determine from the feedback message 225 which of the beams 205 may correspond to a highest peak energy and use that beam to estimate the distance zₘ. In other cases, wireless device 115-a may perform an uplink centric procedure in which wireless device 115-a transmits reference signals using one or more beams 215 to wireless device 105-a. Wireless device 105-a may determine a highest peak energy corresponding to the received reference signal and estimate a distance zₘ based on the received reference signal. Additionally, or alternatively, wireless device 105-a may make an initial distance estimation of zₘ based on RTT or by applying a hypothesis for the distance.

Wireless device 105-a may perform a focus Fourier transform using the estimated distance zₘ (e.g., estimated depth parameter to focus a beam in the near field) to get an estimate of the location of each of the multiple objects. Wireless device 105-a may identify one or more signal sources, including wireless device 115-a, based on identifying the locations of the multiple objects. Additionally, or alternatively, wireless device 105-a may identify differences in the relative phase of one or more reference signals used in the focus Fourier transform.

Wireless device 105-a may determine one or more parameters for performing three-dimensional beamforming based on the estimated locations for the multiple objects. The parameters may include one or more antenna phases for one or more antenna phases for a corresponding one or more antenna elements of wireless device 105-a and define a direction and actual focus depth for a three-dimensional beamforming procedure. In some cases, wireless device 105-a may use an estimated receiver channel response for three-dimensional beamforming weights, such as in low data rate transmissions (e.g., control information transmissions) in which wireless device 105-a uses the estimated channel response as the matched filter for transmission. However, in other cases, such as high data rate transmission, wireless device 105-a may improve performance by using a single strong point for focusing energy.

Wireless device 105-a may perform three-dimensional beamforming with wireless device 115-a using beam 210, which may be defined by the determined parameters. In some implementations, wireless device 105-a may also use the results of the focus Fourier transform for applications other than three-dimensional beamforming such as characterizing reflections. For example, wireless device 105-a may calculate reflections losses. Additionally, or alternatively, wireless device 105-a may classify a reflector as a diffusive reflector if an energy cluster instead of a clear source point is identified.

In some aspects, an artificial intelligence model (e.g., neural network based pattern recognition algorithm), may replace the focus Fourier transform. Accordingly, wireless device 105-a may train the artificial intelligence model using the phase in the received signal and effectively fit the phase with an estimate of the quantity of sources, each of which may be at a different location. As such, the artificial intelligence may be a non-linear equation solver for equation (7) in which m, xₘ, yₘ, and zₘ may be unknown.

$$A ( x , y ) = {\sum }_{m = 0}^{M - 1} {a}_{m} exp ( jk \sqrt{{( x - {x}_{m} )}^{2} + {( y - {y}_{m} )}^{2} + {z}_{m}^{2}} ) + noise \qquad ( 7 )$$

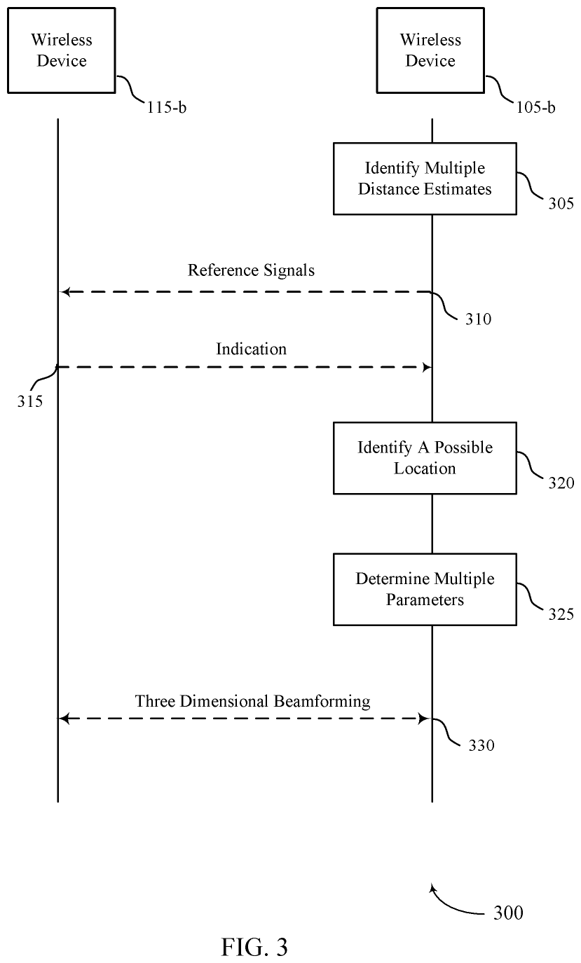

FIG. 3 illustrates an example of a process flow 300 that supports three dimensional search and positioning in wireless communications systems in accordance with one or more aspects of the present disclosure. In some examples, the process flow 300 may implement or be implemented by aspects of the wireless communications systems 100 and 200 as described with reference to FIGS. 1 and 2, respectively. For example, the process flow 300 may be implemented by wireless device 105-b, which may be an example of a network entity 105 as described with reference to FIGS. 1 and 2, and wireless device 115-b, which may be an example of a UE 115 as described with reference to FIGS. 1 and 2.

Additionally or alternatively, wireless device 105-b may be an example of a UE 115 and wireless device 115-b may be an example of a network entity 105, as described with reference to FIGS. 1 and 2. In the following description of the process flow 300, the operations between the wireless device 105-b and wireless device 115-b may be transmitted in a different order than the example order shown, or the operations performed by the wireless device 105-b and wireless device 115-b may be performed in different orders or at different times. Some operations may also be omitted from the process flow 300, and other operations may be added to the process flow 300.

At 305, wireless device 105-b may identify multiple distance estimates along a coordinate value for a first direction (e.g., z direction) of a distance between wireless device 105-b and wireless device 115-b. In some cases, at least one of the set of distance estimates may correspond to a reflection of wireless device 115-b, and wireless device 105-b may use the distance estimates to characterize reflectors.

At 310, wireless device 105-b may optionally transmit a set of reference signals to wireless device 115-b. At 315, wireless device 115-b may optionally transmit an indication to the wireless device 105-b. The indication may be based on the set of reference signals received at 310.

At 320, wireless device 105-b may identify a possible location of wireless device 115-b using a pair of coordinate values for a second and a third direction (e.g., x and y direction). Wireless device 105-b may identify the location by performing a focus Fourier transform using the coordinate value of the first direction as an input. In some cases, the location identified at 320 may optionally be based on an indication received from wireless device 115-b at 315. Wireless device 115-b may transmit an indication at 315 based on receiving reference signals from wireless device 105-b at 310. Specifically, wireless device 105-b may transmit multiple three-dimensional beamformed reference signal to multiple locations and distances based on the multiple distances estimated at 305. At 315, wireless device 105-b may receive from multiple wireless devices including wireless device 115-b, respective indications of corresponding ones of the multiple three-dimensional beamformed reference signal. In some cases, the corresponding one of the set of three-dimensional beamformed reference signal may be associated with the peak energy received at the multiple wireless devices, and wireless device 105-b may identify possible locations at 320 based at least in part on the indications received at 315.

At 325, wireless device 105-b wireless device 105-b may determine, based on the multiple distance estimates and possible location of wireless device 115-b, multiple parameters for a three-dimensional beamforming procedure. The parameters may be a location and a determined distance of wireless device 115-b and wireless device 105-b may use the parameters as inputs to a three-dimensional beamforming procedure.

At 330 wireless device 105-b may perform a three-dimensional beamforming procedure during wireless communication with wireless device 115-b using at least one of the parameters determined at 325. In some cases, wireless device 105-b may further perform the three-dimensional beamforming procedure using an estimated channel response as a matched filter for determining the multiple parameters for transmitting a three-dimensional beam. In some cases, wireless device 105-b may perform the three-dimensional beamforming procedure in association with a channel estimation signal-to-noise ratio satisfying a threshold.

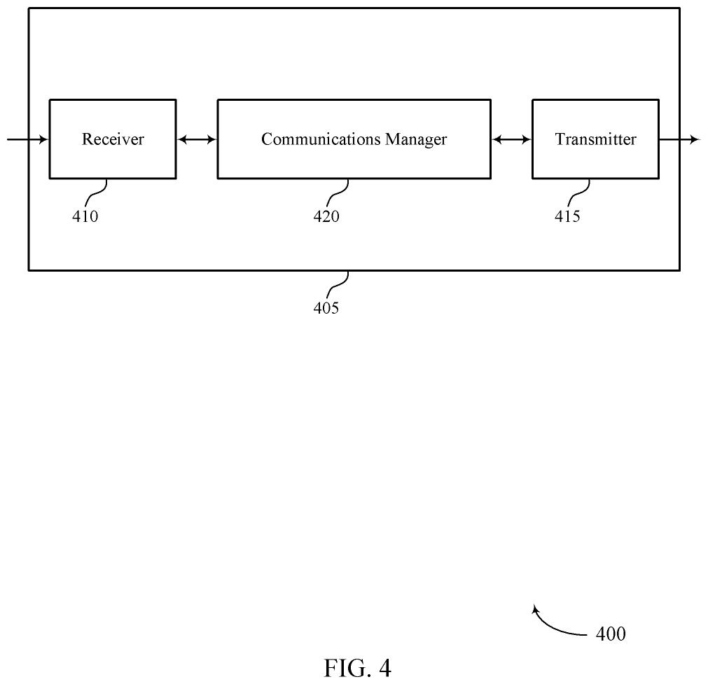

FIG. 4 shows a block diagram 400 of a device 405 that supports three dimensional search and positioning in wireless communications systems in accordance with one or more aspects of the present disclosure. The device 405 may be an example of aspects of a UE 115 or a network entity 105 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to three dimensional search and positioning in wireless communications systems). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to three dimensional search and positioning in wireless communications systems). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of three dimensional search and positioning in wireless communications systems as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a first wireless device in accordance with examples as disclosed herein. For example, the communications manager 420 may be configured as or otherwise support a means for identifying a set of multiple estimates of distance for a set of devices in a first direction between the first wireless device and a second wireless device. As described in FIG. 2, the communications manager 420 may support means for using a searcher or cross-correlation based timing estimation, the phase of the received waveform, or scanning to estimate a distance. The communications manager 420 may be configured as or otherwise support a means for identifying a possible location using a pair of coordinate values for a second direction and a third direction, where the possible location is for the second wireless device in relation to the first wireless device. The communications manager 420 may be configured as or otherwise support a means for determining, based on the set of multiple estimates of distance and the possible location of the second wireless device, a set of multiple parameters for a three-dimensional beamforming procedure, the set of multiple parameters including inputs to the three-dimensional beamforming procedure. The communications manager 420 may be configured as or otherwise support a means for communicating with the second wireless device in accordance with the three-dimensional beamforming procedure.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for more efficient utilization of communication resources.

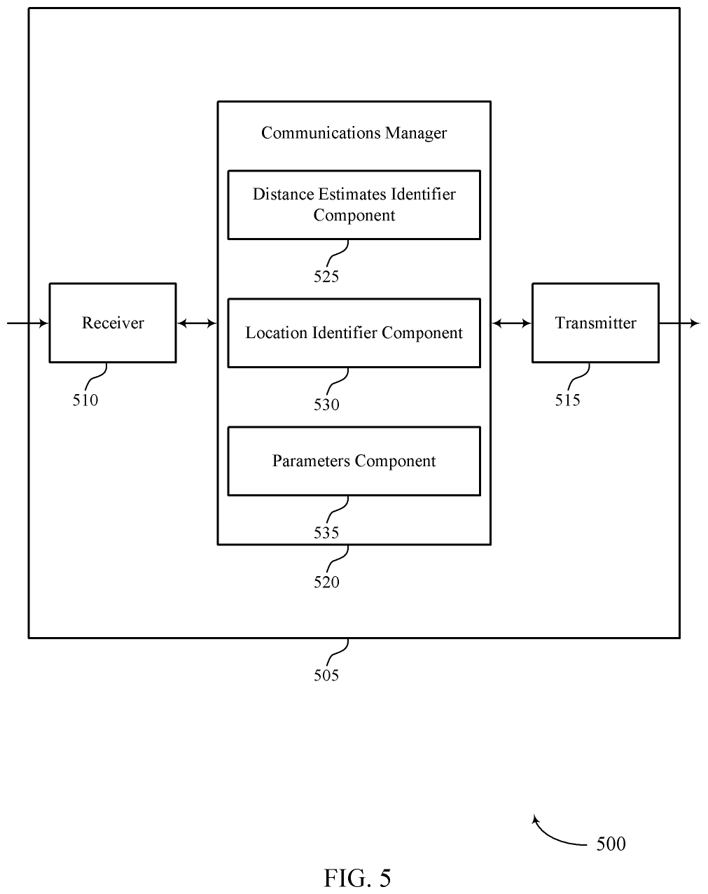

FIG. 5 shows a block diagram 500 of a device 505 that supports three dimensional search and positioning in wireless communications systems in accordance with one or more aspects of the present disclosure. The device 505 may be an example of aspects of a device 405, a UE 115, or a network entity 105 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to three dimensional search and positioning in wireless communications systems). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to three dimensional search and positioning in wireless communications systems). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of three dimensional search and positioning in wireless communications systems as described herein. For example, the communications manager 520 may include a distance estimates identifier component 525, a location identifier component 530, a parameters component 535, or any combination thereof. The communications manager 520 may be an example of aspects of a communications manager 420 as described herein. As described in FIG. 2, the communications manager 520 may support means for using a searcher or cross-correlation based timing estimation, the phase of the received waveform, or scanning to estimate a distance. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a first wireless device in accordance with examples as disclosed herein. The distance estimates identifier component 525 may be configured as or otherwise support a means for identifying a set of multiple estimates of distance for a set of devices in a first direction between the first wireless device and a second wireless device. The location identifier component 530 may be configured as or otherwise support a means for identifying a possible location using a pair of coordinate values for a second direction and a third direction, where the possible location is for the second wireless device in relation to the first wireless device. The parameters component 535 may be configured as or otherwise support a means for determining, based on the set of multiple estimates of distance and the possible location of the second wireless device, a set of multiple parameters for a three-dimensional beamforming procedure, the set of multiple parameters including inputs to the three-dimensional beamforming procedure. The parameters component 535 may be configured as or otherwise support a means for communicating with the second wireless device in accordance with the three-dimensional beamforming procedure.

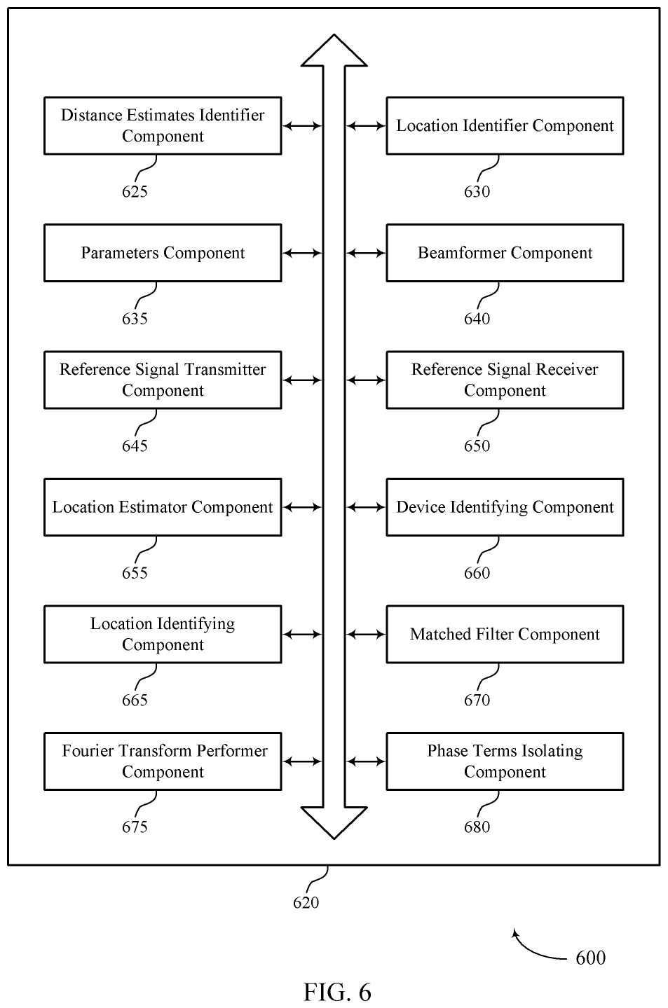

FIG. 6 shows a block diagram 600 of a communications manager 620 that supports three dimensional search and positioning in wireless communications systems in accordance with one or more aspects of the present disclosure. The communications manager 620 may be an example of aspects of a communications manager 420, a communications manager 520, or both, as described herein. The communications manager 620, or various components thereof, may be an example of means for performing various aspects of three dimensional search and positioning in wireless communications systems as described herein. For example, the communications manager 620 may include a distance estimates identifier component 625, a location identifier component 630, a parameters component 635, a beamformer component 640, a reference signal transmitter component 645, a reference signal receiver component 650, a location estimator component 655, a device identifying component 660, a location identifying component 665, a matched filter component 670, a Fourier transform performer component 675, a phase terms isolating component 680, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 620 may support wireless communication at a first wireless device in accordance with examples as disclosed herein. The distance estimates identifier component 625 may be configured as or otherwise support a means for identifying a set of multiple estimates of distance for a set of devices in a first direction between the first wireless device and a second wireless device. As described in FIG. 2, the communications manager 620 may be configured for using a searcher or cross-correlation based timing estimation, the phase of the received waveform, or scanning to estimate a distance. The location identifier component 630 may be configured as or otherwise support a means for identifying a possible location using a pair of coordinate values for a second direction and a third direction, where the possible location is for the second wireless device in relation to the first wireless device. The parameters component 635 may be configured as or otherwise support a means for determining, based on the set of multiple estimates of distance and the possible location of the second wireless device, a set of multiple parameters for a three-dimensional beamforming procedure, the set of multiple parameters including inputs to the three-dimensional beamforming procedure. The parameters component 635 may be configured as or otherwise support a means for communicating with the second wireless device in accordance with the three-dimensional beamforming procedure.

In some examples, the beamformer component 640 may be configured as or otherwise support a means for performing the three-dimensional beamforming procedure during wireless communication between the first wireless device and the second wireless device using at least one of the determined set of multiple parameters. In some examples, to support performing the three-dimensional beamforming procedure, the matched filter component 670 may be configured as or otherwise support a means for using an estimated channel response for determining the set of multiple parameters for transmitting a three-dimensional beam.

In some examples, performing the three-dimensional beamforming procedure is associated with a channel estimation signal-to-noise-ratio satisfying a threshold. In some examples, identifying the possible location of the second wireless device includes performing a Fourier transform using a coordinate value for the first direction as an input.

In some examples, the Fourier transform is performed using an approximation of an x-coordinate that increases an angular resolution. In some examples, at least one of the set of multiple estimates of distance corresponds to a reflection of the second wireless device. In some examples, the set of multiple parameters include one or more of a set of multiple antenna phases for a corresponding one or more of a set of multiple antenna elements at the first wireless device.

In some examples, to support identifying the possible location of the second wireless device, the reference signal transmitter component 645 may be configured as or otherwise support a means for transmitting a set of multiple three-dimensional beamformed reference signals at a set of multiple locations and at a set of multiple distances based on the set of multiple estimates of distance. In some examples, to support identifying the possible location of the second wireless device, the reference signal receiver component 650 may be configured as or otherwise support a means for receiving, from a set of multiple signal sources including the second wireless device, respective indications of corresponding ones of the set of multiple three-dimensional beamformed reference signals, the corresponding ones of the set of multiple three-dimensional beamformed reference signals being associated with peak received energy at each of the set of multiple signal sources, where the respective locations of the set of multiple signal sources are identified based on the respective indications.

In some examples, to support identifying the possible location of the second wireless device, the reference signal receiver component 650 may be configured as or otherwise support a means for receiving, from a set of multiple signal sources including the second wireless device, one or more reference signals. In some examples, to support identifying the possible location of the second wireless device, the location estimator component 655 may be configured as or otherwise support a means for estimating respective locations of the set of multiple signal sources based on differences in relative phase of the one or more reference signals, as received at different antenna elements of the first wireless device.

In some examples, to support estimating respective locations of the set of multiple signal sources, the Fourier transform performer component 675 may be configured as or otherwise support a means for performing a Fourier transform based on the one or more reference signals and the identified estimates of distance in order to identify the differences in relative phase of the one or more reference signals.

In some examples, to support determining the set of multiple parameters, the phase terms isolating component 680 may be configured as or otherwise support a means for isolating one or more phase terms from the Fourier transform, where the one or more phase terms are included in the set of multiple parameters.

In some examples, the device identifying component 660 may be configured as or otherwise support a means for identifying a set of multiple signal sources including the second wireless device based on identifying the respective locations of the set of multiple signal sources, where the set of multiple signal sources includes one or a set of multiple physical objects and one or a set of multiple reflections of the set of multiple physical objects.

In some examples, to support identifying the possible location of the second wireless device, the location identifying component 665 may be configured as or otherwise support a means for identifying respective locations of a set of multiple signal sources including the second wireless device based on an output from a neural network.

In some examples, the first wireless device and the second wireless device are not within line of sight of each other. In some examples, the set of multiple estimates of distance are used to characterize reflectors.

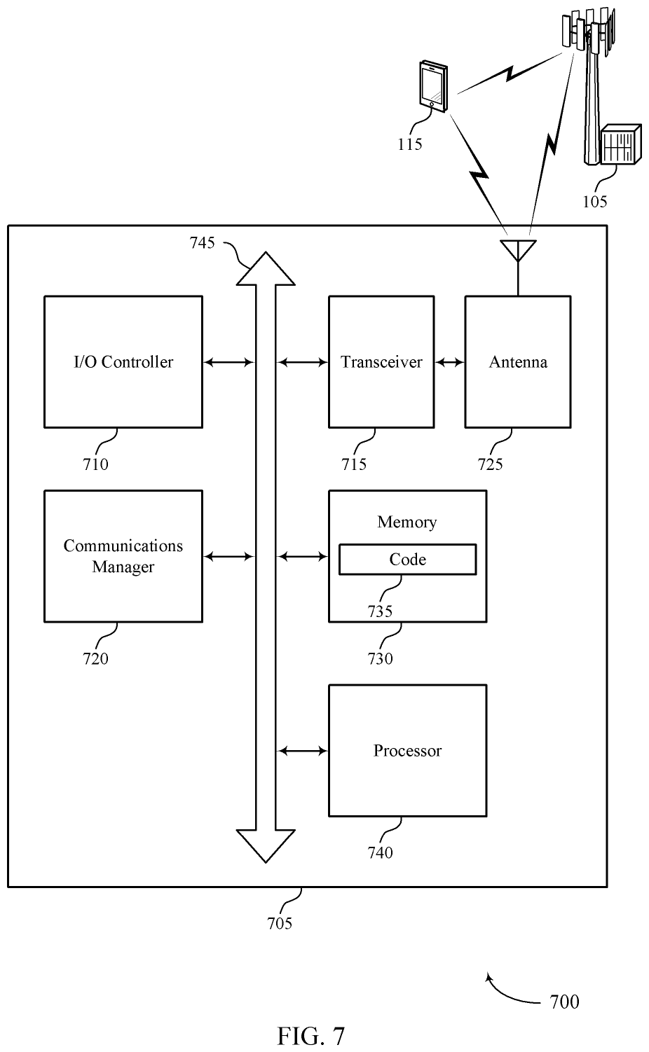

FIG. 7 shows a diagram of a system 700 including a device 705 that supports three dimensional search and positioning in wireless communications systems in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOSR, ANDROIDR, MS-DOSR, MS-WINDOWS®, OS/2R, UNIXR, LINUXR, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting three dimensional search and positioning in wireless communications systems). For example, the device 705 or a component of the device 705 may include a processor 740 and memory 730 coupled with or to the processor 740, the processor 740 and memory 730 configured to perform various functions described herein.

The communications manager 720 may support wireless communication at a first wireless device in accordance with examples as disclosed herein. For example, the communications manager 720 may be configured as or otherwise support a means for identifying a set of multiple estimates of distance for a set of devices in a first direction between the first wireless device and a second wireless device. The communications manager 720 may be configured as or otherwise support a means for identifying a possible location using a pair of coordinate values for a second direction and a third direction, where the possible location is for the second wireless device in relation to the first wireless device. The communications manager 720 may be configured as or otherwise support a means for determining, based on the set of multiple estimates of distance and the possible location of the second wireless device, a set of multiple parameters for a three-dimensional beamforming procedure, the set of multiple parameters including inputs to the three-dimensional beamforming procedure. The communications manager 720 may be configured as or otherwise support a means for communicating with the second wireless device in accordance with the three-dimensional beamforming procedure.

By including or configuring the communications manager 720 in accordance with examples as described herein, the device 705 may support techniques for improved communication reliability, more efficient utilization of communication resources, and improved coordination between devices.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of three dimensional search and positioning in wireless communications systems as described herein, or the processor 740 and the memory 730 may be otherwise configured to perform or support such operations.

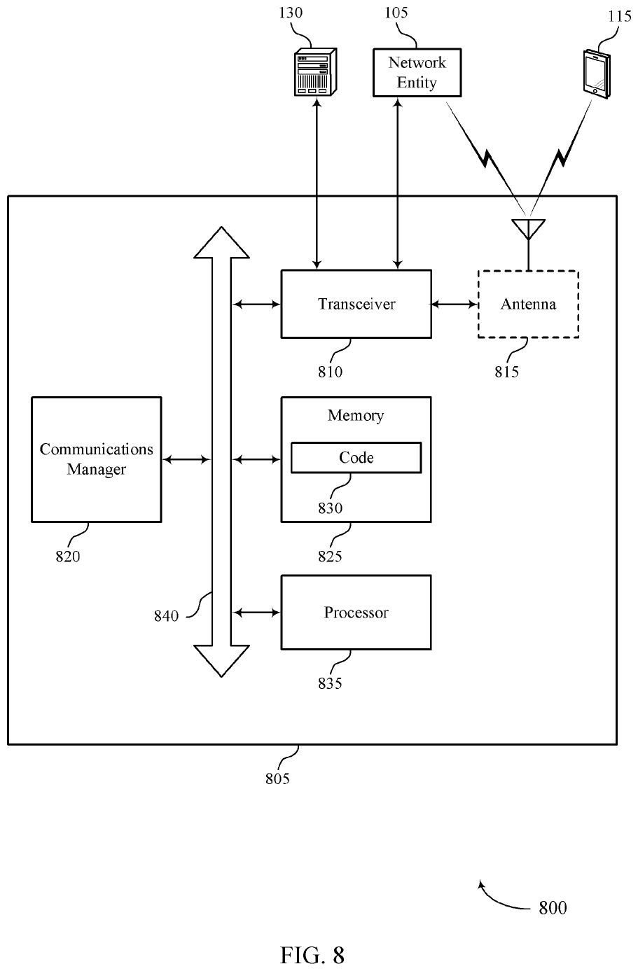

FIG. 8 shows a diagram of a system 800 including a device 805 that supports three dimensional search and positioning in wireless communications systems in accordance with one or more aspects of the present disclosure. The device 805 may be an example of or include the components of a device 405, a device 505, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, a memory 825, code 830, and a processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or memory components (for example, the processor 835, or the memory 825, or both), may be included in a chip or chip assembly that is installed in the device 805. In some examples, the transceiver may be operable to support communications via one or more communications links (e.g., a communication link 125, a backhaul communication link 120, a midhaul communication link 162, a fronthaul communication link 168).

The memory 825 may include RAM and ROM. The memory 825 may store computer-readable, computer-executable code 830 including instructions that, when executed by the processor 835, cause the device 805 to perform various functions described herein. The code 830 may be stored in a non-transitory computer-readable medium such as system memory or another type of memory. In some cases, the code 830 may not be directly executable by the processor 835 but may cause a computer (e.g., when compiled and executed) to perform functions described herein. In some cases, the memory 825 may contain, among other things, a BIOS which may control basic hardware or software operation such as the interaction with peripheral components or devices.

The processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 835 may be configured to operate a memory array using a memory controller. In some other cases, a memory controller may be integrated into the processor 835. The processor 835 may be configured to execute computer-readable instructions stored in a memory (e.g., the memory 825) to cause the device 805 to perform various functions (e.g., functions or tasks supporting three dimensional search and positioning in wireless communications systems). For example, the device 805 or a component of the device 805 may include a processor 835 and memory 825 coupled with the processor 835, the processor 835 and memory 825 configured to perform various functions described herein. The processor 835 may be an example of a cloud-computing platform (e.g., one or more physical nodes and supporting software such as operating systems, virtual machines, or container instances) that may host the functions (e.g., by executing code 830) to perform the functions of the device 805. The processor 835 may be any one or more suitable processors capable of executing scripts or instructions of one or more software programs stored in the device 805 (such as within the memory 825). In some implementations, the processor 835 may be a component of a processing system. A processing system may generally refer to a system or series of machines or components that receives inputs and processes the inputs to produce a set of outputs (which may be passed to other systems or components of, for example, the device 805). For example, a processing system of the device 805 may refer to a system including the various other components or subcomponents of the device 805, such as the processor 835, or the transceiver 810, or the communications manager 820, or other components or combinations of components of the device 805. The processing system of the device 805 may interface with other components of the device 805, and may process information received from other components (such as inputs or signals) or output information to other components. For example, a chip or modem of the device 805 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 805 may transmit information output from the chip or modem. Additionally, or alternatively, in some implementations, the one or more interfaces may refer to an interface between the processing system of the chip or modem and a receiver, such that the device 805 may obtain information or signal inputs, and the information may be passed to the processing system. A person having ordinary skill in the art will readily recognize that a first interface also may obtain information or signal inputs, and a second interface also may output information or signal outputs.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the memory 825, the code 830, and the processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communication at a first wireless device in accordance with examples as disclosed herein. For example, the communications manager 820 may be configured as or otherwise support a means for identifying a set of multiple estimates of distance for a set of devices in a first direction between the first wireless device and a second wireless device. The communications manager 820 may be configured as or otherwise support a means for identifying a possible location using a pair of coordinate values for a second direction and a third direction, where the possible location is for the second wireless device in relation to the first wireless device. The communications manager 820 may be configured as or otherwise support a means for determining, based on the set of multiple estimates of distance and the possible location of the second wireless device, a set of multiple parameters for a three-dimensional beamforming procedure, the set of multiple parameters including inputs to the three-dimensional beamforming procedure. The communications manager 820 may be configured as or otherwise support a means for communicating with the second wireless device in accordance with the three-dimensional beamforming procedure.

By including or configuring the communications manager 820 in accordance with examples as described herein, the device 805 may support techniques for improved communication reliability, more efficient utilization of communication resources, and improved coordination between devices.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, the processor 835, the memory 825, the code 830, or any combination thereof. For example, the code 830 may include instructions executable by the processor 835 to cause the device 805 to perform various aspects of three dimensional search and positioning in wireless communications systems as described herein, or the processor 835 and the memory 825 may be otherwise configured to perform or support such operations.

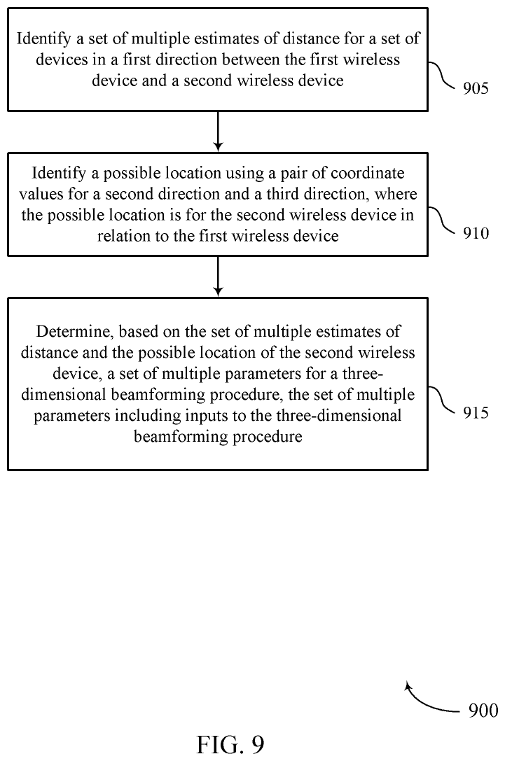

FIG. 9 shows a flowchart illustrating a method 900 that supports three dimensional search and positioning in wireless communications systems in accordance with one or more aspects of the present disclosure. The operations of the method 900 may be implemented by a UE or a network entity or its components as described herein. For example, the operations of the method 900 may be performed by a UE 115 or a network entity as described with reference to FIGS. 1 through 8. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 905, the method may include identifying a set of multiple estimates of distance for a set of devices in a first direction between the first wireless device and a second wireless device. The operations of 905 may be performed in accordance with examples as disclosed herein. Specifically, as described in FIG. 2 the method may include using a searcher or cross-correlation based timing estimation, the phase of the received waveform, or scanning to estimate the distances. In some examples, aspects of the operations of 905 may be performed by a distance estimates identifier component 625 as described with reference to FIG. 6.

At 910, the method may include identifying a possible location using a pair of coordinate values for a second direction and a third direction, where the possible location is for the second wireless device in relation to the first wireless device. The operations of 910 may be performed in accordance with examples as disclosed herein, including FIG. 2 which describes performing a Fourier transform using the estimated distance. In some examples, aspects of the operations of 910 may be performed by a location identifier component 630 as described with reference to FIG. 6.

At 915, the method may include determining, based on the set of multiple estimates of distance and the possible location of the second wireless device, a set of multiple parameters for a three-dimensional beamforming procedure, the set of multiple parameters including inputs to the three-dimensional beamforming procedure. The operations of 915 may be performed in accordance with examples as disclosed herein. In some examples, aspects of the operations of 915 may be performed by a parameters component 635 as described with reference to FIG. 6.

At 920, the method may include communicating with the second wireless device in accordance with the three-dimensional beamforming procedure. The operations of 920 may be performed in accordance with examples as disclosed herein. In some examples, aspects of the operations of 920 may be performed by a parameters component 635 as described with reference to FIG. 6

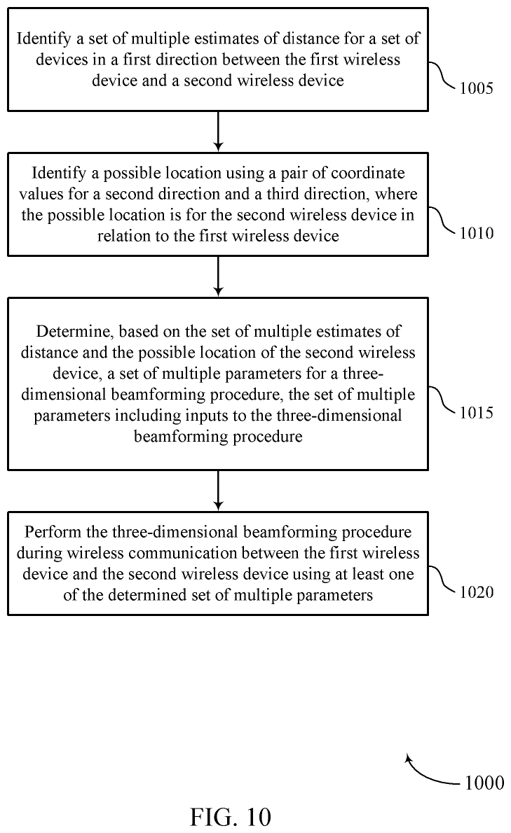

FIG. 10 shows a flowchart illustrating a method 1000 that supports three dimensional search and positioning in wireless communications systems in accordance with one or more aspects of the present disclosure. The operations of the method 1000 may be implemented by a UE or a network entity or its components as described herein. For example, the operations of the method 1000 may be performed by a UE 115 or a network entity as described with reference to FIGS. 1 through 8. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1005, the method may include identifying a set of multiple estimates of distance for a set of devices in a first direction between the first wireless device and a second wireless device. The operations of 1005 may be performed in accordance with examples as disclosed herein. Specifically, as described in FIG. 2, the operations 1005 may include using a searcher or cross-correlation based timing estimation, the phase of the received waveform to estimate a distance, or scanning to estimate a distance. In some examples, aspects of the operations of 1005 may be performed by a distance estimates identifier component 625 as described with reference to FIG. 6.

At 1010, the method may include identifying a possible location using a pair of coordinate values for a second direction and a third direction, where the possible location is for the second wireless device in relation to the first wireless device. The operations of 1010 may be performed in accordance with examples as disclosed herein. In some examples, aspects of the operations of 1010 may be performed by a location identifier component 630 as described with reference to FIG. 6.

At 1015, the method may include determining, based on the set of multiple estimates of distance and the possible location of the second wireless device, a set of multiple parameters for a three-dimensional beamforming procedure, the set of multiple parameters including inputs to the three-dimensional beamforming procedure. The operations of 1015 may be performed in accordance with examples as disclosed herein. In some examples, aspects of the operations of 1015 may be performed by a parameters component 635 as described with reference to FIG. 6.

At 1020, the method may include performing the three-dimensional beamforming procedure during wireless communication between the first wireless device and the second wireless device using at least one of the determined set of multiple parameters. The operations of 1020 may be performed in accordance with examples as disclosed herein. In some examples, aspects of the operations of 1020 may be performed by a beamformer component 640 as described with reference to FIG. 6.

The following provides an overview of aspects of the present disclosure:

Aspect 1: A method for wireless communication at a first wireless device, comprising: identifying a plurality of estimates of distance for a plurality of devices in a first direction between the first wireless device and a second wireless device: identifying a possible location using a pair of coordinate values for a second direction and a third direction, wherein the possible location is for the second wireless device in relation to the first wireless device: determining, based at least in part on the plurality of estimates of distance and the possible location of the second wireless device, a plurality of parameters for a three-dimensional beamforming procedure, the plurality of parameters comprising inputs to the three-dimensional beamforming procedure; and communicating with the second wireless device in accordance with the three-dimensional beamforming procedure.

Aspect 2: The method of aspect 1, further comprising: performing the three-dimensional beamforming procedure during wireless communication between the first wireless device and the second wireless device using at least one of the determined plurality of parameters.

Aspect 3: The method of aspect 2, wherein performing the three-dimensional beamforming procedure further comprises: using an estimated channel response for determining the plurality of parameters for transmitting a three-dimensional beam.

Aspect 4: The method of any of aspects 2 through 3, wherein performing the three-dimensional beamforming procedure is associated with a channel estimation signal-to-noise-ratio satisfying a threshold.

Aspect 5: The method of any of aspects 1 through 4, wherein identifying the possible location of the second wireless device comprises performing a Fourier transform using a coordinate value for the first direction as an input.

Aspect 6: The method of aspect 5, wherein the focus Fourier transform is performed using an approximation of an x-coordinate that increases an angular resolution.

Aspect 7: The method of any of aspects 1 through 6, wherein at least one of the plurality of estimates of distance corresponds to a reflection of the second wireless device.

Aspect 8: The method of any of aspects 1 through 7, wherein the plurality of parameters comprise one or more of a plurality of antenna phases for a corresponding one or more of a plurality of antenna elements at the first wireless device.

Aspect 9: The method of any of aspects 1 through 8, wherein identifying the possible location of the second wireless device further comprises: transmitting a plurality of three-dimensional beamformed reference signals at a plurality of locations and at a plurality of distances based at least in part on the plurality of estimates of distance; and receiving, from a plurality of signal sources comprising the second wireless device, respective indications of corresponding ones of the plurality of three-dimensional beamformed reference signals, the corresponding ones of the plurality of three-dimensional beamformed reference signals being associated with peak received energy at each of the plurality of signal sources, wherein the respective locations of the plurality of signal sources are identified based at least in part on the respective indications.

Aspect 10: The method of any of aspects 1 through 9, wherein identifying the possible location of the second wireless device further comprises: receiving, from a plurality of signal sources comprising the second wireless device, one or more reference signals; and estimating respective locations of the plurality of signal sources based at least in part on differences in relative phase of the one or more reference signals, as received at different antenna elements of the first wireless device.

Aspect 11: The method of aspect 10, wherein estimating respective locations of the plurality of signal sources further comprises: performing a Fourier transform based on the one or more reference signals and the identified estimates of distance in order to identify the differences in relative phase of the one or more reference signals.

Aspect 12: The method of aspect 11, wherein determining the plurality of parameters further comprises: isolating one or more phase terms from the Fourier transform, wherein the one or more phase terms are included in the plurality of parameters.

Aspect 13: The method of any of aspects 1 through 12, further comprising: identifying a plurality of signal sources comprising the second wireless device based at least in part on identifying the respective locations of the plurality of signal sources, wherein the plurality of signal sources comprises one or a plurality of physical objects and one or a plurality of reflections of the plurality of physical objects.

Aspect 14: The method of any of aspects 1 through 13, wherein identifying the possible location of the second wireless device further comprises: identifying respective locations of a plurality of signal sources comprising the second wireless device based at least in part on an output from a neural network.

Aspect 15: The method of any of aspects 1 through 14, wherein the first wireless device and the second wireless device are not within line of sight of each other.

Aspect 16: The method of any of aspects 1 through 15, wherein the plurality of estimates of distance are used to characterize reflectors.

Aspect 17: An apparatus for wireless communication at a first wireless device, comprising a processor: memory coupled with the processor; and instructions stored in the memory and executable by the processor to cause the apparatus to perform a method of any of aspects 1 through 16.

Aspect 18: An apparatus for wireless communication at a first wireless device, comprising at least one means for performing a method of any of aspects 1 through 16.

Aspect 19: A non-transitory computer-readable medium storing code for wireless communication at a first wireless device, the code comprising instructions executable by a processor to perform a method of any of aspects 1 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communication at a first wireless device, comprising:
identifying a plurality of estimates of distance for a plurality of devices in a first direction between the first wireless device and a second wireless device;
identifying a possible location using a pair of coordinate values for a second direction and a third direction, wherein the possible location is for the second wireless device in relation to the first wireless device;
determining, based at least in part on the plurality of estimates of distance and the possible location of the second wireless device, a plurality of parameters for a three-dimensional beamforming procedure, the plurality of parameters comprising inputs to the three-dimensional beamforming procedure; and
communicating with the second wireless device in accordance with the three-dimensional beamforming procedure.

2. The method of claim 1, further comprising:
performing the three-dimensional beamforming procedure during wireless communication between the first wireless device and the second wireless device using at least one of the determined plurality of parameters.

3. The method of claim 2, wherein performing the three-dimensional beamforming procedure further comprises:
using an estimated channel response for determining the plurality of parameters for transmitting a three-dimensional beam.

4. (canceled)

5. The method of claim 1, wherein at least one of the plurality of estimates of distance corresponds to a reflection of the second wireless device.

6. The method of claim 1, wherein identifying the possible location of the second wireless device comprises performing a Fourier transform using a coordinate value for the first direction as an input.

7. (canceled)

8. The method of claim 1, wherein the plurality of parameters comprise one or more of a plurality of antenna phases for a corresponding one or more of a plurality of antenna elements at the first wireless device.

9. The method of claim 1, wherein identifying the possible location of the second wireless device further comprises:
transmitting a plurality of three-dimensional beamformed reference signals at a plurality of locations and at a plurality of distances based at least in part on the plurality of estimates of distance; and
receiving, from a plurality of signal sources comprising the second wireless device, respective indications of corresponding ones of the plurality of three-dimensional beamformed reference signals, the corresponding ones of the plurality of three-dimensional beamformed reference signals being associated with peak received energy at each of the plurality of signal sources, wherein the respective locations of the plurality of signal sources are identified based at least in part on the respective indications.

10. The method of claim 1, wherein identifying the possible location of the second wireless device further comprises:
receiving, from a plurality of signal sources comprising the second wireless device, one or more reference signals; and
estimating respective locations of the plurality of signal sources based at least in part on differences in relative phase of the one or more reference signals, as received at different antenna elements of the first wireless device.

11-12. (canceled)

13. The method of claim 1, further comprising:
identifying a plurality of signal sources comprising the second wireless device based at least in part on identifying the respective locations of the plurality of signal sources, wherein the plurality of signal sources comprises one or a plurality of physical objects and one or a plurality of reflections of the plurality of physical objects.

14. The method of claim 1, wherein identifying the possible location of the second wireless device further comprises:
identifying respective locations of a plurality of signal sources comprising the second wireless device based at least in part on an output from a neural network.

15. The method of claim 1, wherein the first wireless device and the second wireless device are not within line of sight of each other.

16. (canceled)

17. An apparatus for wireless communication, comprising:
a processor;
memory coupled with the processor; and
instructions stored in the memory and executable by the processor to cause the apparatus to:
identify a plurality of estimates of distance for a plurality of devices in a first direction between a first wireless device and a second wireless device;
identify a possible location using a pair of coordinate values for a second direction and a third direction, wherein the possible location is for the second wireless device in relation to the first wireless device;
determine, based at least in part on the plurality of estimates of distance and the possible location of the second wireless device, a plurality of parameters for a three-dimensional beamforming procedure, the plurality of parameters comprising inputs to the three-dimensional beamforming procedure; and
communicating with the second wireless device in accordance with the three-dimensional beamforming procedure.

18. The apparatus of claim 17, wherein the instructions are further executable by the processor to cause the apparatus to:
perform the three-dimensional beamforming procedure during wireless communication between the first wireless device and the second wireless device using at least one of the determined plurality of parameters.

19. The apparatus of claim 18, wherein the instructions to perform the three-dimensional beamforming procedure are further executable by the processor to cause the apparatus to:
use an estimated channel response for determining the plurality of parameters for transmitting a three-dimensional beam.

20. (canceled)

21. The apparatus of claim 17, wherein at least one of the plurality of estimates of distance corresponds to a reflection of the second wireless device.

22. The apparatus of claim 17, wherein identifying the possible location of the second wireless device comprises performing a Fourier transform using a coordinate value for the first direction as an input.

23. (canceled)

24. The apparatus of claim 17, wherein the plurality of parameters comprise one or more of a plurality of antenna phases for a corresponding one or more of a plurality of antenna elements at the first wireless device.

25. The apparatus of claim 17, wherein the instructions to identify the possible location of the second wireless device are further executable by the processor to cause the apparatus to:
transmit a plurality of three-dimensional beamformed reference signals at a plurality of locations and at a plurality of distances based at least in part on the plurality of estimates of distance; and
receive, from a plurality of signal sources comprising the second wireless device, respective indications of corresponding ones of the plurality of three-dimensional beamformed reference signals, the corresponding ones of the plurality of three-dimensional beamformed reference signals being associated with peak received energy at each of the plurality of signal sources, wherein the respective locations of the plurality of signal sources are identified based at least in part on the respective indications.

26. The apparatus of claim 17, wherein the instructions to identify the possible location of the second wireless device are further executable by the processor to cause the apparatus to:
receive, from a plurality of signal sources comprising the second wireless device, one or more reference signals; and
estimate respective locations of the plurality of signal sources based at least in part on differences in relative phase of the one or more reference signals, as received at different antenna elements of the first wireless device.

27-29. (canceled)

30. A non-transitory computer-readable medium storing code for wireless communication at a first wireless device, the code comprising instructions executable by a processor to:
identify a plurality of estimates of distance for a plurality of devices in a first direction between the first wireless device and a second wireless device;
identify a possible location using a pair of coordinate values for a second direction and a third direction, wherein the possible location is for the second wireless device in relation to the first wireless device;
determine, based at least in part on the plurality of estimates of distance and the possible location of the second wireless device, a plurality of parameters for a three-dimensional beamforming procedure, the plurality of parameters comprising inputs to the three-dimensional beamforming procedure; and
communicating with the second wireless device in accordance with the three-dimensional beamforming procedure.
